(19) United States
(12) Patent Application Publication
(10) Pub. No.: US 2020/0077675 A1
(43) Pub. Date: Mar. 12, 2020

(54) Candy Floss Composition And Apparatus For Making Chopped Candy Floss

(71) Applicant: Jorge Ramos Peart, Santa Catarina (MX)

(72) Inventor: Jorge Ramos Peart, Santa Catarina (MX)

(21) Appl. No.: 16/563,806

(22) Filed: Sep. 6, 2019

Related U.S. Application Data
(60) Provisional application No. 62/728,069, filed on Sep. 6, 2018.

(51) Int. Cl. A23G 3/42; A23G 3/40; A23G 3/10

(52) U.S. Cl. CPC A23G 3/42; A23G 3/10; A23G 3/40

(57) ABSTRACT

A candy floss composition and an apparatus for creating individual pieces of candy floss that do not bond to one another are provided. The candy floss composition comprises about 99.99% to about 45% by weight of candy floss ingredients, and about 0.01% to about 55% by weight of vegetable fat, adjusted to bring the total weight percentage of the candy floss composition to 100%. Vegetable fat changes physical attributes of the candy floss ingredients. During the manufacture of candy floss, heat applied to the candy floss ingredients melts the vegetable fat and sugar to produce candy floss filaments comprising vegetable fat with a film of vegetable fat. When a slab of candy floss is chopped into individual pieces in a candy floss chopper apparatus, the vegetable fat film on each candy floss filament makes candy floss substantially soft and precludes bonding of individual pieces of candy floss to one another.

### CROSS-REFERENCE TO RELATED APPLICATIONS

This application claims priority to and the benefit of the provisional patent application titled “Candy Floss Composition”, application number 62/728,069, filed in the United States Patent and Trademark Office on Sep. 06, 2018. The specification of the above referenced patent application is incorporated herein by reference in its entirety.

### BACKGROUND

Candy floss, also known as cotton candy is candy made with candy floss ingredients comprising, for example, sugar, artificial and/or natural flavors, and artificial and/or natural colors. In general, the candy floss ingredients are mixed together in a commercially available solid ingredient mixer, and then poured into a candy floss maker and processed to produce slabs of candy floss. The candy floss maker comprises a head member with heating elements located near the rim of the head member. When the candy floss maker is powered on, the head member spins at a high speed and the heating elements melt sugar along with the other candy floss ingredients poured into the spinning head member of the candy floss maker. The head member of the candy floss maker comprises openings through which the melted ingredients are squeezed out to produce candy floss filaments. Candy floss formed from the candy floss filaments are rolled into a cone or packaged, for example, packaged in tubes, bags, or containers for human consumption.

Candy floss is typically chopped into individual pieces of different shapes, for example, round balls to be used, for example, as cake toppings and beverage toppings. As the composition of commercially marketed candy floss is hygroscopic, i.e., tends to absorb moisture from the environmental air, it is difficult to chop candy floss into individual pieces of candy floss because the individual pieces of candy floss stick to each other. Furthermore, currently available candy floss dissolves immediately in cold liquids and does not float in cold liquids. Furthermore, currently available candy floss is not soft. Furthermore, currently available candy floss cannot be made in high humidity and hot weather environments as the candy floss absorbs moisture from the environment.

Hence, there is a long felt but unresolved need for a candy floss composition that precludes bonding of individual pieces of candy floss to one another. Furthermore, there is a need for an apparatus for creating individual, soft pieces of candy floss that absorb minimal moisture from the ambient environment, for example, high humidity and hot weather environments, that do not bond to one another, that do not dissolve immediately in cold liquids, that floats in cold liquids, and that is substantially softer than candy floss currently available in the market.

### SUMMARY OF THE INVENTION

The composition disclosed herein addresses the above recited need for a candy floss composition that that preclude bonding of individual pieces of candy floss to another. Furthermore, disclosed herein is a method for making individual, soft pieces of candy floss that absorb minimal moisture from the ambient environment, for example, high humidity and hot weather environments, that do not dissolve immediately in cold liquids, that float in cold liquids, and that are substantially softer than candy floss currently available in the market. The candy floss composition disclosed herein comprises about 99.99% to about 45% by weight of candy floss ingredients, for example, sugar, artificial and/or natural flavors, artificial and/or natural colors, etc., or any combination thereof, and about 0.01% to about 55% by weight of vegetable fat, for example, palm stearin, adjusted to bring the total weight percentage of the candy floss composition to 100%. During the manufacture of the candy floss, the candy floss ingredients are heated in the candy floss maker to about the melting point of the sugar. In an embodiment, during the manufacture of the candy floss, the candy floss composition is heated to a temperature selected from the range of about 300° F. to about 340° F. In another embodiment, during the manufacture of the candy floss, the candy floss ingredients are heated in the candy floss maker to about 320° F. The heat applied to the candy floss ingredients melts and mixes the vegetable fat with the cotton floss and coats the candy floss filaments with a film of the vegetable fat, thereby changing the physical attributes of the candy floss ingredients, for example, produces candy floss filaments that minimize absorption of moisture from the ambient environment, precludes bonding of the individual candy floss filaments to one another, etc.

Also disclosed herein is a candy floss chopper apparatus for making individual, soft pieces of candy floss that absorb minimal moisture from the ambient environment for example, high humidity and hot weather environments, that do not dissolve immediately in cold liquids, that float in cold liquids, and that are substantially softer than candy floss currently available in the market. The candy floss chopper apparatus comprises a support table, a candy floss container attached to a top surface of the support table, a floss chopper compactor adapted to slide in and out of the candy floss container through a first end of the candy floss container, at least one screen attached to a second end of the candy floss container, a motor comprising a shaft, and at least one propeller attached to the shaft inside the candy floss container. The screen comprises an axial slot on a face of the screen. The shaft of the motor extends into the candy floss container through the axial slot of the screen. The propeller comprises at least one blade that is disposed proximal to the screen. When a slab of candy floss is chopped into individual pieces in the candy floss chopper apparatus by the blade on the propeller, the vegetable fat in the candy floss composition and the vegetable fat coating on each of the candy floss filaments in the candy floss pieces makes the candy floss pieces substantially soft and precludes bonding of the individual pieces of candy floss. The candy floss pieces produced absorb minimal moisture from the ambient environment, do not dissolve immediately in cold liquids, float in cold liquids, and are substantially softer than candy floss pieces currently available in the market.

### BRIEF DESCRIPTION OF THE DRAWINGS

FIGS. 1A and 1B exemplarily illustrate tabular representations showing formulations of a candy floss composition used for creating individual, soft pieces of candy floss that do not bond to one another.

FIG. 2 exemplarily illustrates a prior art candy floss maker.

FIG. 3A exemplarily illustrates a perspective view of a candy floss chopper apparatus for creating individual, soft pieces of candy floss that do not bond to one another.

FIG. 3B exemplarily illustrates a sectional view of the candy floss chopper apparatus for creating individual, soft pieces of candy floss that do not bond to one another.

FIG. 4 exemplarily illustrates a screen used in the candy floss chopper apparatus.

### DETAILED DESCRIPTION OF THE INVENTION

Disclosed herein is a candy floss composition comprising about 45% to about 99.99% by weight of candy floss ingredients, and about 0.01% to about 55% by weight of vegetable fat, for example, palm stearin, adjusted to bring the total weight percentage of the candy floss composition to 100%. The candy floss ingredients comprise, for example, sugar, one or more artificial and/or natural flavors, one or more artificial and/or natural colors, etc., or any combination thereof. Palm stearin is a solid fraction of palm oil. Palm stearin is produced from palm oil by partially crystallizing palm oil at a controlled temperature. Palm stearin or other vegetable fat used as an ingredient in the manufacture of the candy floss, changes the physical attributes of the candy floss ingredients to minimize moisture absorption from the ambient environment by the candy floss pieces, and precludes bonding of individual pieces of candy floss. The amount of palm stearin or other vegetable fat used in the candy floss composition depends upon the end use of the candy floss or candy floss pieces. Increasing the palm stearin or other vegetable fat used in the manufacture of the candy, increases the time the candy floss floats in a cold liquid, and decreases the amount of moisture absorbed from the ambient environment. For example, individual pieces of candy floss made from a candy floss composition comprising about 99.99% to about 50% by weight of the candy floss ingredients and about 0.01% to about 50% by weight of palm stearin float in cold liquids for about 15 minutes, before the candy floss dissolves in cold liquids. In another example, individual pieces of candy floss created from a candy floss composition comprising about 99.95% to about 45% by weight of the candy floss ingredients and about 0.05% to about 55% by weight of palm stearin absorbs less moisture from the ambient environment, thereby allowing the individual pieces of candy floss to be softer, to retain their shapes, and to float in cold liquids for a longer period of time compared to commercially available candy floss. Therefore, this candy floss composition is used to make toppings that are used for floating on cold beverages, etc.

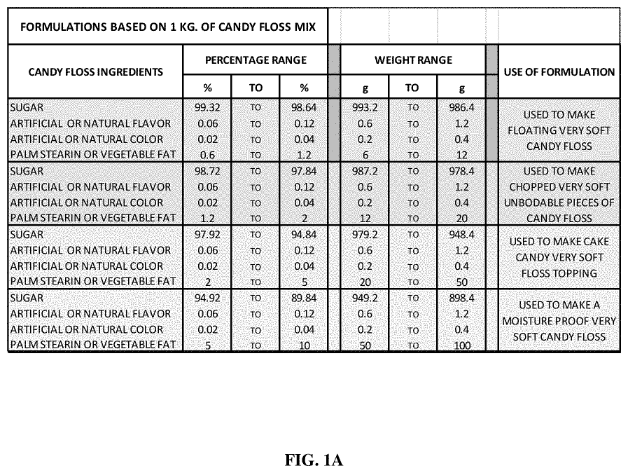

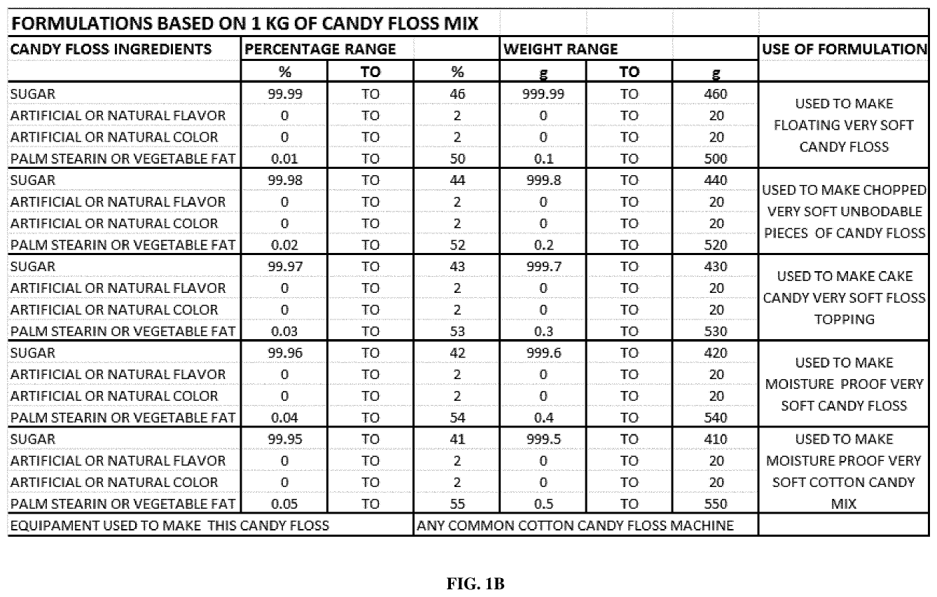

FIG. 1A exemplarily illustrates a tabular representation of formulations of candy floss compositions used for creating individual, soft pieces of candy floss that do not bond to one another. The compositions disclosed in FIG. 1A are used to make individual, pieces of candy floss that do not bond to one another, that absorb minimal moisture from the ambient environment, for example high humidity and hot weather environments, that do not dissolve immediately in cold liquids, that float in cold liquids, and that are substantially softer than candy floss currently available in the market.

Example 1: A candy floss composition comprising about 99.32% to about 98.64% by weight of sugar, about 0.06% to about 0.12% by weight of artificial and/or natural flavor, about 0.02% to about 0.04% by weight of artificial and/or natural color, and about 0.6% to about 1.2% by weight of palm stearin or other vegetable fat is mixed in a mixer and poured into a candy floss maker and processed in the candy floss maker to produce a slab of substantially soft candy floss the filaments of which do not bond with one another and that floats in cold liquids.

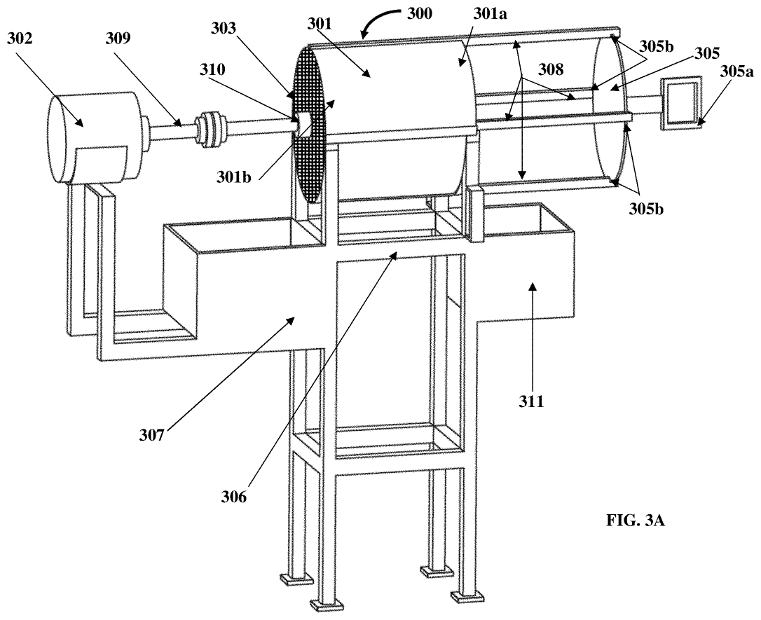

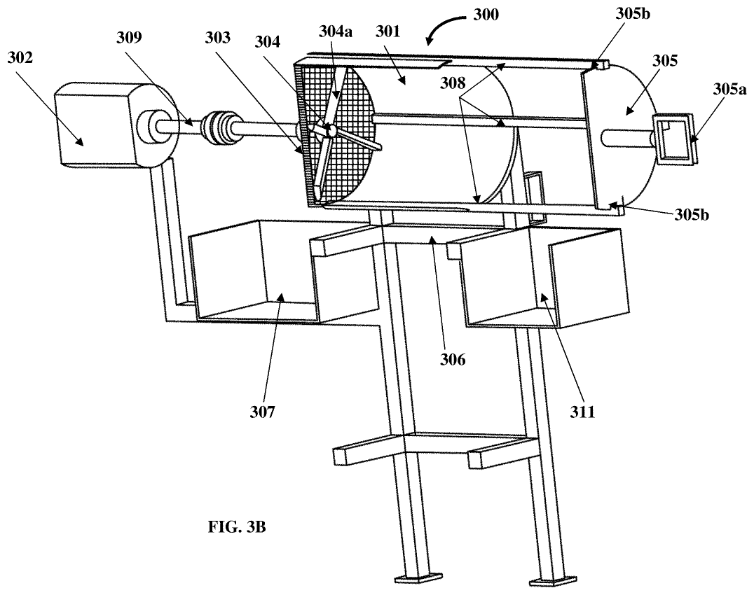

Example 2: A candy floss composition comprising about 98.72% to about 97.84% by weight of sugar, about 0.06% to about 0.12% by weight of artificial and/or natural flavor, about 0.02% to about 0.04% by weight of artificial and/or natural color, and about 1.2% to about 2% by weight of palm stearin or other vegetable fat is mixed in a mixer and poured into a candy floss maker to produce a slab of substantially soft candy floss that can be chopped into individual, pieces of candy floss that do not bond to one another in a candy floss chopper apparatus 300 exemplarily illustrated in FIGS. 3A-3B.

Example 3: A candy floss composition comprising about 97.92% to about 94.84% by weight of sugar, about 0.06% to about 0.12% by weight of artificial and/or natural flavor, about 0.02% to about 0.04% by weight of artificial and/or natural color, and about 2% to about 5% by weight of palm stearin or other vegetable fat is mixed in a mixer and poured into a candy floss maker to produce a slab of substantially soft candy floss, the filaments of which do not bond to one another and that can be used to make substantially soft toppings, for example, cake toppings.

Example 4: A candy floss composition comprising about 94.92% to about 89.84% by weight of sugar, about 0.06% to about 0.12% by weight of artificial and/or natural flavor, about 0.02% to about 0.04% by weight of artificial and/or natural color, and about 5% to about 10% by weight of palm stearin or other vegetable fat is mixed in a mixer and poured into a candy floss maker to produce a slab of substantially soft candy floss the filaments of which do not bond to one another.

FIG. 1B exemplarily illustrates another tabular representation showing formulations of candy floss composition used for creating individual, soft pieces of candy floss the filaments of which do not bond to one another. Examples of the candy floss composition used to create individual, pieces of candy floss that minimize moisture absorption from the ambient environment, that do not dissolve immediately in cold liquids, that float in cold liquids, and that are substantially softer than candy floss commercially available in the market are disclosed below.

Example 5: A candy floss composition comprising about 99.99% to about 46% by weight of sugar, about 0% to about 2% by weight of artificial and/or natural flavor, about % to about 2% by weight of artificial and/or natural color, and about 0.01% to about 50% by weight of palm stearin or other vegetable fat is mixed in a mixer and poured into a candy floss maker to produce a slab of substantially soft candy floss the filaments of which do not bond to one another and that floats in cold beverages. The candy floss produced using this composition does not immediately melt in cold liquids and is therefore used as a topping to decorate cold beverages.

Example 6: A candy floss composition comprising about 99.98% to about 44% by weight of sugar, about 0% to about 2% by weight of artificial and/or natural flavor, about 0% to about 2% by weight of artificial and/or natural color, and about 0.02% to about 52% by weight of palm stearin or other vegetable fat is mixed in a mixer and poured into a candy floss maker to produce a slab of substantially soft candy floss the filaments of which do not bond to one another and that can be chopped into individual, pieces of candy floss in a candy floss chopper apparatus 300 exemplarily illustrated in FIGS. 3A-3B. The candy floss is combined with cereal to make floating cotton candy cereal that is further combined with a variety of candies or edible products to make the combination more attractive.

Example 7: A candy floss composition comprising about 99.97% to about 43% by weight of sugar, about 0% to about 2% by weight of artificial and/or natural flavor, about 0% to about 2% by weight of artificial and/or natural color, and about 0.03% to about 53% by weight of palm stearin or other vegetable fat is mixed in a mixer and poured into a candy floss maker to produce a slab of substantially soft candy floss that can be used to make substantially soft toppings, for example, cake toppings.

Example 8: A candy floss composition comprising about 99.96% to about 42% by weight of sugar, about 0% to about 2% by weight of artificial and/or natural flavor, about 0% to about 2% by weight of artificial and/or natural color, and about 0.04% to about 54% by weight of palm stearin or other vegetable fat is mixed in a mixer and poured into a candy floss maker to produce a slab of substantially soft candy floss that is minimizes the absorption of moisture from the ambient environment.

Example 9: A candy floss composition comprising about 99.95% to about 41% by weight of sugar, about 0% to about 2% by weight of artificial and/or natural flavor, about 0% to about 2% by weight of artificial and/or natural color, and about 0.05% to about 55% by weight of palm stearin or other vegetable fat is mixed in a mixer and poured into a candy floss maker to produce a slab of soft candy floss that minimizes absorption from the environment. This candy floss composition is used to make substantially soft, floating, cotton candy floss that does not dissolve in cold beverages. Therefore, the cotton candy floss is used as cold beverage topping. The substantially soft cotton candy floss melts in the mouth of a consumer without the consumer being able to feel the sugar crystals in his or her mouth.

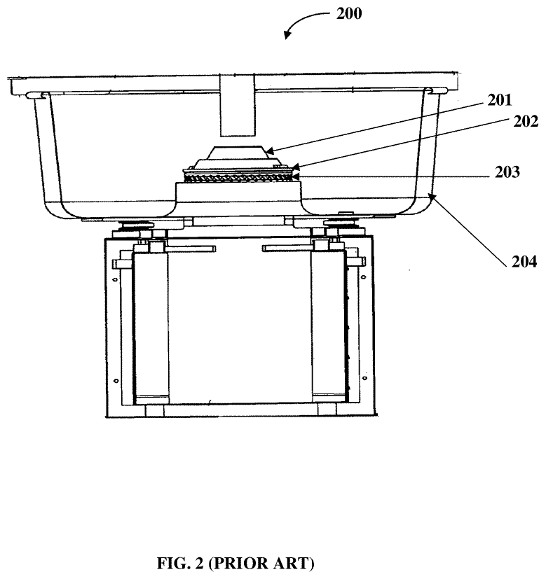

Individual pieces of candy floss that do not bond to one another are created by mixing about 45% to about 99.9% by weight of the candy floss ingredients disclosed above and about 0.01% to about 55% by weight of vegetable fat, for example, palm stearin, in a mixer. For example, about 98% to about 98.8% by weight of candy floss ingredients such as sugar, one or more artificial and/or natural flavors, and one or more artificial and/or natural colors, and about 1.2% to about 2% by weight of palm stearin or other vegetable fat, adjusted to bring the total weight percentage of the candy floss composition to 100%, are mixed in a mixer (not shown). The candy floss maker 200 comprises a head member 201 and heating elements (not shown) positioned proximal to the rim 202 of the head member 201. The mixed ingredients are poured into the candy floss maker 200, as exemplarily illustrated in FIG. 2, and heated at a preset temperature sufficient to melt the sugar in the candy floss composition. In an embodiment, the mixed sugar and vegetable fat ingredients are heated at a preset temperature selected from a range between about 300° F.-340° F. When the candy floss maker 200 is powered on, the head member 201 spins at a preset, high rotational speed selected between about 1800 rpm and 3000 rpm; the heating elements (not shown) melt the vegetable fat with the sugar, and the melted, mixed ingredients is fed into the spinning head member 201 of the candy floss maker 200. The head member 201 of the candy floss maker 200 comprises small peripheral openings 203 through which the melted ingredients are squeezed out into the chamber 204 to produce candy floss filaments comprising the vegetable fat and coated with a film of the vegetable fat. The filaments of the candy floss do not bond to one another.

In an embodiment, the candy floss filaments comprising the vegetable fat and coated with a film of the vegetable fat are scooped manually and stacked by an operator to produce the slab of candy floss. The slab of candy floss is then transferred into a candy floss container 301 of a candy floss chopper apparatus 300 exemplarily illustrated in FIGS. 3A-3B, for chopping into individual pieces of candy floss as disclosed in the detailed description of FIGS. 3A-3B.

FIGS. 3A-3B exemplarily illustrate a perspective view and a sectional view of the candy floss chopper apparatus 300 respectively, for making individual pieces of candy floss that do not bond to one another. The candy floss chopper apparatus 300 comprises a support table 306, a candy floss container 301 attached to a top surface of the support table 306, a candy floss chopper compactor 305 adapted to compact the candy floss in the candy floss container 30 by moving in and out of the candy floss container 301 through a first end 301a of the candy floss container 301, at least one screen 303 attached to a second end 301b of the candy floss container 301, a motor 302 comprising a shaft 309 and at least one propeller 304 attached to the shaft 309 inside the candy floss container 301. The screen 303 comprises an axial slot 310 on a face of the screen 303. The shaft 309 of the motor 302 extends into the candy floss container 301 through the axial slot 310 of the screen 303. The propeller 304 comprises at least one blade 304a that is disposed proximal to the screen 303. In an embodiment, the motor 302 is a variable speed motor.

The candy floss container 301 is rigidly attached to the support table 306. The support table 306 comprises a first container 311 below the first end 301a of the candy floss container 301, and a second container 307 below the second end 301b of the candy floss container 301. The motor 302 is mounted on the support table 306. The shaft 309 of the motor 302 is coaxial with the axial slot 310 of the screen 303. In an embodiment, the propeller 304 comprises multiple blades 304a disposed proximal to the screen 303. In an embodiment, the candy floss container 301 comprises multiple guiderails 308 located along a length of the candy floss container 301 on an inner periphery of the candy floss container 301. Each of the guiderails 308 is equidistant from one or more adjacent guiderails 308, as shown in FIGS. 3A and 3B. The floss chopper compactor 305 comprises slots 305b on the perimeter of the floss chopper compactor 305. Each of the slots 305b is configured to slidably engage with one of guiderails 308, as shown in FIG. 3B. The floss chopper compactor 305 engages with the guiderails 308 to allow the floss chopper compactor 305 to be pushed into the candy floss container 301 and pulled out of the candy floss container 301. In an embodiment, the floss chopper compactor 305 comprises a handle 305a to facilitate the movement of the floss chopper compactor 305 into and out of the candy floss container 301.

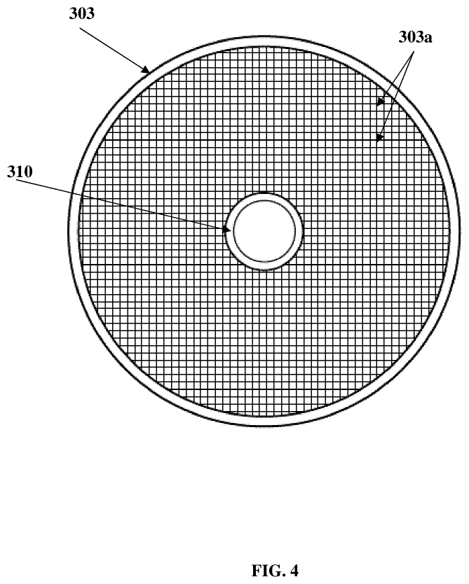

A slab of candy floss is transferred to the candy floss container 301 from the candy floss maker 201. In an embodiment, an operator may pre-compress the slab of candy floss manually and transfer the slab of candy floss into the candy floss container 301 until the candy floss container 301 is filled to about 75% its volume. When the candy floss chopper apparatus 300 is powered on, the motor 302 rotates the propeller 304 connected to the shaft 309. When an operator pushes the floss chopper compactor 305 into the candy floss container 301, the floss chopper compactor 305 moves the slab candy floss towards the blade 304a of the propeller 304. The propeller 304 chops the slab of candy floss into individual pieces of candy floss. The floss chopper is pushed by an operator towards the second end 301b of the compactor 305 of the candy floss container 301 to initiate chopping of the slab of candy floss into individual pieces of candy floss by the propeller 304. The individual pieces of candy floss fall by gravity into the second container 307 and are collected in the second container 307. The vegetable fat coating on each of the candy floss filaments in the individual pieces of candy floss precludes bonding of the individual pieces of candy floss to one another. In an embodiment, the sizes of the individual pieces of candy floss are changed by changing the screen 303 with a screen of a different mesh opening cut-out 303a, and the speed of the variable speed motor 302. In an embodiment, the screen 303 comprises a design cutout 303a made in the screen 303, as shown in FIG. 4. In an embodiment, the design cutout 303a made in the screen 303 comprises square patterns, as shown in FIG. 4. In another embodiment, the design cutout comprises heart shaped patterns, circular patterns, etc. When the second container 307 is full, the individual pieces of candy floss are removed and packed immediately, for example, in pouches.

The individual pieces of candy floss can be chopped in different sizes and shapes, for example, as cubes, sticks, etc., and can be used, for example, as decorative cake toppings as the individual candy floss pieces absorb less moisture, and as decorative beverage toppings as the individual pieces of candy floss float in cold beverages. The individual pieces of candy floss can also be used as decorations, for example, for weddings, parties, etc., as the candy floss pieces can be exposed to moisture or humidity without being damaged.

The foregoing examples have been provided merely for explanation and are in no way to be construed as limiting of the candy floss composition and the method disclosed herein. While the candy floss composition and the method have been described with reference to various embodiments, it is understood that the words, which have been used herein, are words of description and illustration, rather than words of limitation. Furthermore, although the candy floss composition and the method have been described herein with reference to particular means, materials, and embodiments, the candy floss composition and the method are not intended to be limited to the particulars disclosed herein; rather, the candy floss composition and the method extend to all functionally equivalent structures, methods and uses, such as are within the scope of the appended claims. While multiple embodiments are disclosed, it will be understood by those skilled in the art, having the benefit of the teachings of this specification, that the candy floss composition and the method disclosed herein are capable of modifications and other embodiments may be effected and changes may be made thereto, without departing from the scope and spirit of the candy floss composition and the method disclosed herein.

I claim:

1. A candy floss composition, comprising:
about 45% to about 99.99% by weight of candy floss ingredients; and
about 0.01% to about 55% by weight of vegetable fat, adjusted to bring the total weight percentage of the candy floss composition to 100%.

2. The candy floss composition of claim 1, wherein the candy floss ingredients comprise sugar.

3. The candy floss composition of claim 1, wherein the candy floss ingredients comprise one or more artificial flavors.

4. The candy floss composition of claim 1, wherein the candy floss ingredients comprise one or more natural flavors.

5. The candy floss composition of claim 1, wherein the candy floss ingredients comprise one or more artificial colors.

6. The candy floss composition of claim 1, wherein the candy floss ingredients comprise one or more natural colors.

7. The candy floss composition of claim 1, wherein the vegetable fat comprises palm stearin.

8. A candy floss chopper apparatus, comprising:
a support table;
a candy floss container attached to a top surface of the support table;
a floss chopper compactor adapted to slide in and out of the candy floss container through a first end of the candy floss container;
at least one screen attached to a second end of the candy floss container, the at least one screen comprising an axial slot on a face of the at least one screen;
a motor comprising a shaft, the shaft extending into the candy floss container through the axial slot of the at least one screen; and
at least one propeller attached to the shaft inside the candy floss container, the at least one propeller comprising at least one blade disposed proximal to the at least one screen.

9. The candy floss chopper apparatus of claim 8, wherein the motor is a variable speed motor.

10. The candy floss chopper apparatus of claim 8, wherein the support table comprises a first container below the first end of the candy floss container and a second container below the second end of the candy floss container.

11. The candy floss chopper apparatus of claim 8, wherein the floss chopper compactor is configured to be pushed into the candy floss container for compacting the candy floss in the candy floss container.

12. The candy floss chopper apparatus of claim 11, wherein the floss chopper compactor is configured to push the candy floss towards the at least one screen.

13. The candy floss chopper apparatus of claim 8, wherein the propeller comprises a plurality of blades disposed proximal to the at least one screen.

14. The candy floss chopper apparatus of claim 8, wherein the candy floss container comprises a plurality of guiderails located along a length of the candy floss container on an inner periphery of the candy floss container, each of the guiderails being equidistant from one or more of the adjacent guiderails.

15. The candy floss chopper apparatus of claim 14, wherein the floss chopper compactor comprises a plurality of slots on a perimeter of the floss chopper compactor, each of the slots configured to slidably engage with one of the plurality of guiderails.
